(19) United States
(12) Patent Application Publication
(10) Pub. No.: US 2014/0029190 A1
(43) Pub. Date: Jan. 30, 2014

(54) ELECTRONIC DEVICE

(71) Applicant: KABUSHIKI KAISHA TOSHIBA, Tokyo (JP)

(72) Inventors: Yuki SATO, Ome-shi (JP); Yuji NAKAJIMA, Nishitama-gun (JP)

(73) Assignee: KABUSHIKI KAISHA TOSHIBA, Tokyo (JP)

(21) Appl. No.: 13/962,766

(22) Filed: Aug. 8, 2013

Related U.S. Application Data
(63) Continuation of application No. PCT/JP2013/058194, filed on Mar. 14, 2013.

(30) Foreign Application Priority Data
Jul. 25, 2012 (JP) 2012-164882

(51) Int. Cl. G06F 1/16

(52) U.S. Cl. CPC G06F 1/1641
USPC 361/679.27

(57) ABSTRACT

According to one embodiment, an electronic device includes: a flexible display comprising a front surface configured to display an image to be viewed and a rear surface; a first support supporting one end of the display, and positioned on the rear surface across the one end and the other end when the display is approximately flat; a second support supporting the other end, and positioned between the display and the first support; and a hinge rotatably connecting the first and second supports, wherein the electronic device is used in a first configuration in which the first and second supports come near each other and the display becomes approximately flat, and a second configuration in which the first and second supports are separated from each other and the display is bent at a position between the one end and the other end.

### CROSS-REFERENCE TO RELATED APPLICATIONS

This application is a continuation of PCT international application Ser. No. PCT/JP2013/058194, filed on Mar. 14, 2013, which designates the United States, incorporated herein by reference, and which is based upon and claims the benefit of priority from Japanese Patent Application No. 2012-164882, filed on Jul. 25, 2012, the entire contents of which are incorporated herein by reference.

### FIELD

Embodiments described herein relate generally to an electronic device.

### BACKGROUND

Conventionally known is a deformable electronic device with a flexible display.

When housings of a conventional deformable electronic device are folded overlapping each other, for example, thickness increases, to make it difficult to place the electronic device in a case, as an example.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an exemplary electronic device according to an embodiment in a first configuration;

FIG. 2 is an exemplary perspective view of the exemplary electronic device in a second configuration in the embodiment;

FIG. 3 is an exemplary perspective view of the exemplary electronic device in the first configuration with a display removed in the embodiment;

FIG. 4 is an exemplary perspective view of the exemplary electronic device in the second configuration with the display removed in the embodiment;

FIG. 5 is an exemplary side view of the exemplary electronic device in the first configuration in the embodiment;

FIG. 6 is an exemplary side view of the exemplary electronic device in the second configuration in the embodiment;

FIG. 7 is an exemplary cross-sectional view of a second support and the display across VII-VII in FIG. 1;

FIG. 8 is an exemplary front view of the second support of the exemplary electronic device in the first configuration in the embodiment;

FIG. 9 is an exemplary front view of the second support of the exemplary electronic device in the second configuration in the embodiment;

FIG. 10 is an exemplary schematic diagram of a rear surface of a part of the first support in the exemplary electronic device in the first configuration in the embodiment;

FIG. 11 is an exemplary schematic block diagram of a part of a control circuit in the exemplary electronic device in the embodiment;

FIG. 12 is an exemplary cross-sectional view of a part of the exemplary electronic device including a hinge in the first configuration in the embodiment;

FIG. 13 is an exemplary cross-sectional view of the part of the exemplary electronic device including the hinge in the second configuration in the embodiment;

FIG. 14 is an exemplary front view of a second support for an electronic device in a first modification;

FIG. 15 is an exemplary front view of a second support for an electronic device in a second modification;

FIG. 16 is an exemplary schematic diagram of a rear surface of a second support for an electronic device in a third modification;

FIG. 17 is an exemplary plan view of a part of a first support in the electronic device in the third modification; and

FIG. 18 is an exemplary side view of a rear surface of the second support and a fourth support for the electronic device in the third modification.

### DETAILED DESCRIPTION

In general, according to one embodiment, an electronic device comprises: a flexible display comprising a front surface configured to display an image to be viewed and a rear surface located on a side opposite to the front surface; a first support configured to support one end of the display, and to be positioned on the rear surface of the display across the one end and the other end of the display when the display is approximately flat; a second support configured to support the other end of the display, and to be positioned between the display and the first support; and a hinge configured to rotatably connect the first support and the second support, wherein the electronic device is configured to be used in a first configuration in which the first support and the second support come near each other and the display becomes approximately flat, and a second configuration in which the first support and the second support are separated from each other and the display is bent at a position between the one end and the other end.

The same elements are included in an exemplary embodiment and modifications described below. Therefore, the same reference numerals are assigned to the same elements, and redundant explanations thereof are omitted hereunder.

Explained as an example in the embodiment and modifications below is an electronic device configured as a personal computer, but the electronic device according to the embodiments is not limited thereto. For example, the electronic device according to the embodiment may be implemented as various electronic devices such as a television receiver, a cellular phone, a smartphone, a personal digital assistant (PDA), an office appliance, an electronic dictionary, a game machine, a video display device, and a video player.

### First Embodiment

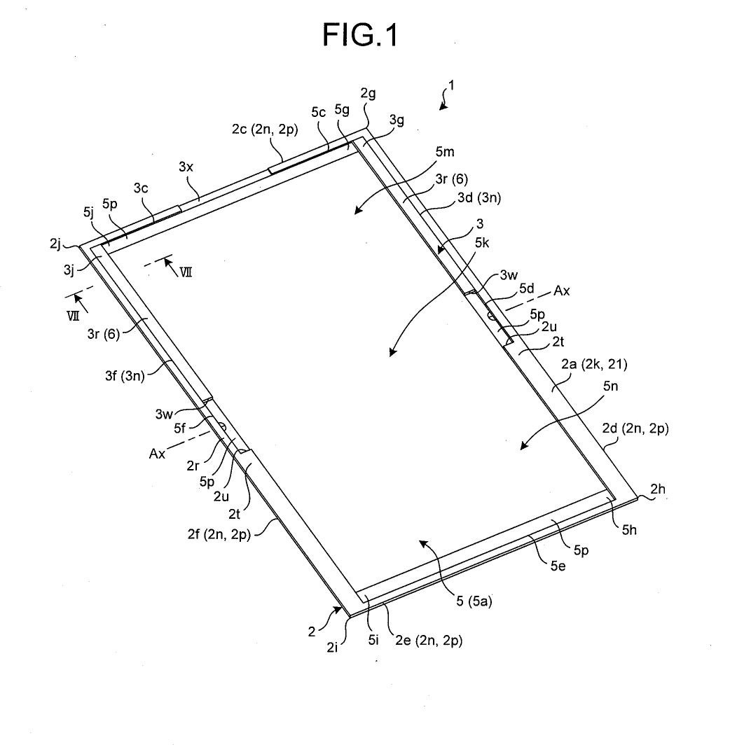

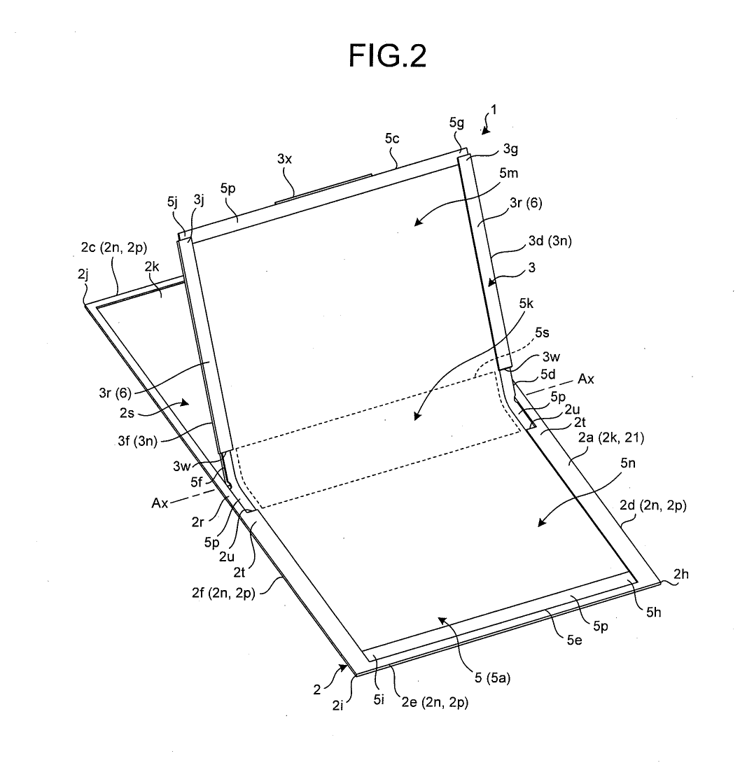

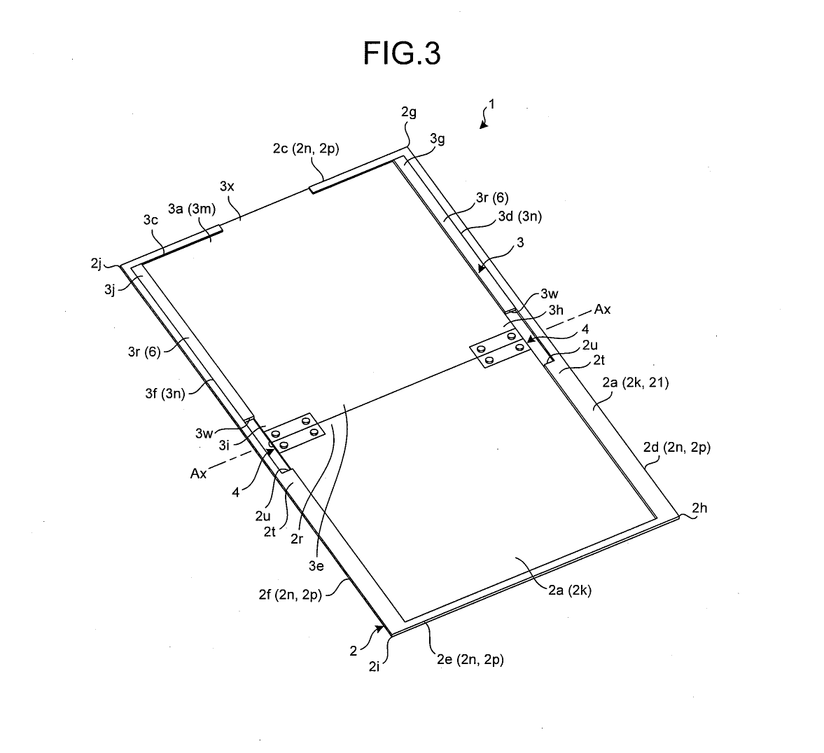

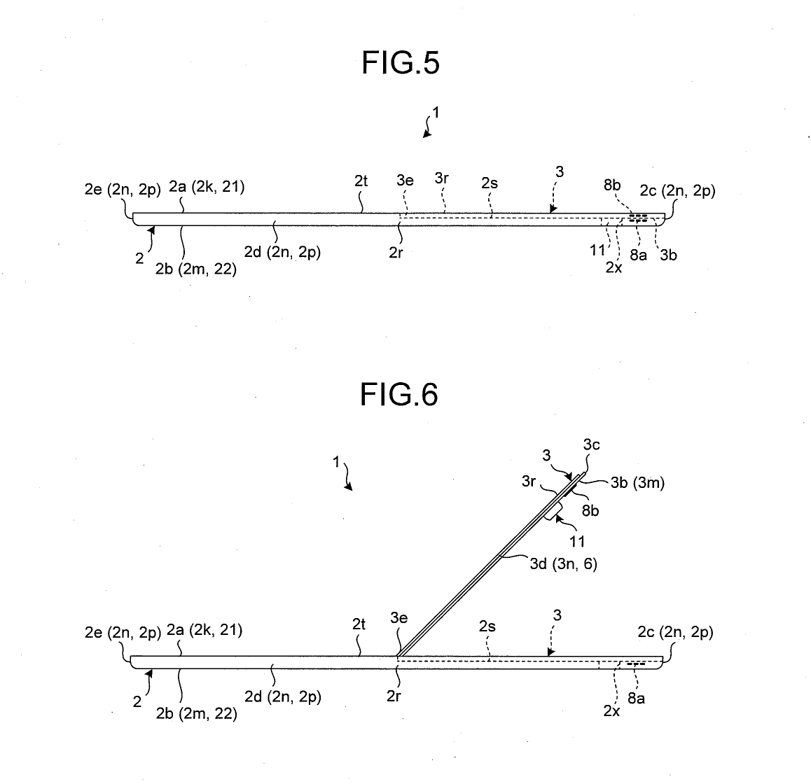

In a first embodiment, as an example, an electronic device 1 comprises a first support 2 (a first housing, a first part) and a second support 3 (a second housing, a second part), as illustrated in FIGS. 1 to 6. A display 5 is supported by the first support 2 and the second support 3. The first support 2 has a flat cube shape that is thin in a thickness direction. The first support 2 has an appearance of a rectangular shape (in the first embodiment, an oblong shape, as an example), viewing in the thickness direction (plan view). The second support 3 has a rectangular (in the first embodiment, oblong, as an example), plate-like shape. As illustrated in FIG. 3, a central part 2r (a center part) of the first support 2 in a longitudinal direction is rotatably connected to one end 3e of the second support 3, using hinges 4, about a rotational axis Ax. The size of the second support 3 viewed in the thickness direction (plan view) is approximately a half of the size of the first support 2 viewed in the thickness direction. The second support 3 can be rotated (moved) between a given position erected from the first support 2 (in the first embodiment, as an example, a position forming an angle of approximately 90 degrees with the first support 2, a position perpendicular to the first support 2, a posture separated from the first support 2, a second posture, a second configuration), and a position laid flat on the side of an end 2c (a position following the first support 2, a position near the first support 2, a first posture, a first configuration). The second support 3 is not allowed to be inclined (rotated, moved) toward an end 2e, which is located on the side opposite to the end 2c with respect to the given position. A recess 2s (an opening) is provided on a surface 2a (a wall 2k) of the first support 2, at a position between the central part 2r and the end 2c, as illustrated in FIG. 2. The second support 3 is housed in the recess 2s in the configuration laid flat on the side of the end 2c illustrated in FIGS. 1, 3, and 5. In the first configuration, a surface 3b of the second support 3 (see FIGS. 5 and 6) is covered by the first support 2, and the first support 2 and the second support 3 come overlapping each other in the thickness direction. The electronic device 1 is provided with a resisting element (for example, a disk spring not illustrated) for giving a resisting torque (resistance against a rotation) between the first support 2 and the second support 3. The resisting element maintains an angle between the first support 2 and the second support 3. When an operator applies a rotating torque that is greater than the resisting torque between the first support 2 and the second support 3, the first support 2 and the second support 3 are rotated (changes their postures). The level of the resisting torque is set a level preventing the first support 2, the second support 3, and the like from moving by weights of themselves or vibrations.

In the first embodiment, as an example, the first support 2 has a surface 2a (a front surface, an upper surface, a frontal surface, a surface portion) and a surface 2b (a rear surface, a bottom surface, a back surface, a surface portion) located on the side opposite to the surface 2a, as illustrated in FIGS. 5 and 6. Both of the surface 2a and the surface 2b extend (expand) along a direction intersecting with (in the first embodiment, as an example, a perpendicular to) the thickness direction of the first support 2. The surface 2a and the surface 2b are approximately in parallel. In the plan view, the first support 2 has four ends 2c to 2f (sides, edges) and four corners 2g to 2j (pointed portions, curved portions, ends), as illustrated in FIGS. 1 to 4. The ends 2c and 2e are examples of short sides. The ends 2d and 2f are examples of long sides.

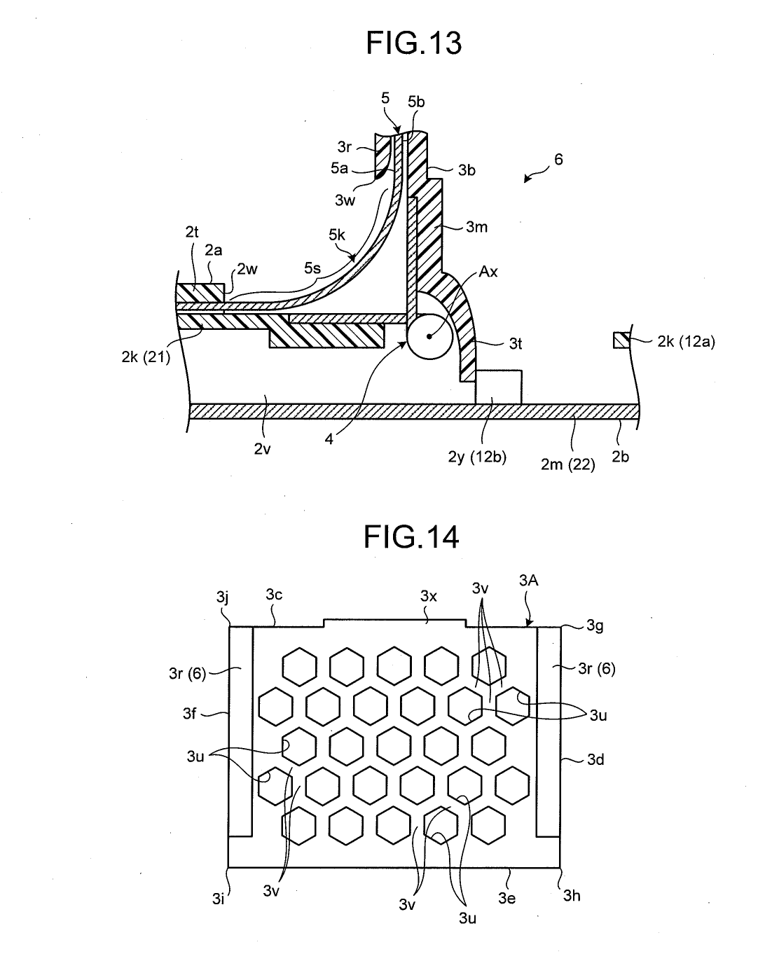

As an example, the first support 2 comprises the wall 2k (a part, a plate, a frame, a front wall, a frontal wall, a top wall) including the surface 2a, and a wall 2m (a part, a plate, a rear wall, a back wall, a bottom wall) including the surface 2b, as illustrated in FIGS. 5 and 6. Both of the walls 2k and 2m have an appearance of a rectangular shape (in the first embodiment, an oblong shape, as an example), viewing in the thickness direction (plan view). The wall 2k and the wall 2m are positioned spaced from each other. The first support 2 also comprises four walls 2n (parts, plates, side walls, end walls, standing walls, stretching portions) including a surface 2p (a side surface, a circumferential surface) stretching between the wall 2k and the wall 2m. A space 2v (see FIGS. 12, 13, and the like) is provided inside of the first support 2. The space 2v is surrounded by the walls 2k, 2m, and 2n, is positioned between the wall 2k and the wall 2m, and stretches across the end 2c and the end 2e and between the end 2d and the end 2f. Various components such as a battery, boards (a circuit board, a control board, a sub-board), various modules, an optical disk drive (ODD), a hard disk drive (HDD), a solid state drive (SSD), an antenna, a camera module, a speaker unit, a connector unit, an operation module unit (a switch), and a sensor unit may be housed in the space 2v. In the first embodiment, as an example, because the space 2v extends over the central part 2r where the hinges 4 are provided, relatively large (wide) components can be housed in the space 2v.

In the first embodiment, as an example, a plurality of components (not illustrated) such as a central processing unit (CPU), a graphic controller, power circuit components, a platform controller hub (PCH), a memory slot connector, a liquid crystal display (LCD) connector, an input/output (I/O) connector, a power coil, an element, a connector, and the like may be implemented on the board that is installed in the space 2v. The control circuit may include a video signal processing circuit, a tuner, a high-definition multimedia interface (HDMI) signal processor, an audio video (AV) input terminal, a remote controller signal receiver, a controller, a selector, an on-screen display, a storage (e.g., a read-only memory (ROM), a random access memory (RAM), an HDD, or an SSD), and an audio signal processing circuit. The control circuit controls video outputs (e.g., moving images or still images) from the display screen (a surface 5a) of the display 5, audio outputs from a speaker (not illustrated), and light outputs from a light emitting diode (LED) (not illustrated). The display 5, the speaker, the LED, and the like are examples of an output module.

The first support 2 may be made from a combination of a plurality of parts (divided portions). In the first embodiment, as an example, the first support 2 comprises a member 21 (a front side member, a mask, a mask portion, a cover, a front cover, a cover portion, a part, an area) at least including the wall 2k, and a member 22 (a rear side member, a base, a base portion, a bottom, a bottom portion, a cover, a rear cover, a cover portion, a part, an area) at least including the wall 2m, as illustrated in FIGS. 5 and 6. The wall 2n is included in at least one of the member 21 and the member 22 (for example, the member 22). The first support 2 may also comprise another member (an intermediate member, an isolating member, a barrier member, a wall member, an interposed member, a covering member, an inner plate, a middle plate, a middle frame, a shield, a part, an area, not illustrated) positioned between the member 21 and the member 22. The first support 2 may be made of a material such as a metal or a synthetic resin. As an example, the member 21 may be made of a synthetic resin material, and the member 22 may be made of a metallic material. Alternatively, the member 21 may be made of a metallic material, and the member 22 may be made of a synthetic resin material. The member 21 and the member 22 may be made of the same material, or may partly include different materials. Walls (protrusions, protruding walls, not illustrated) such as ribs may be provided on the member 21 and the member 22 inside of the first support 2. These walls can increase the stiffness of the first support 2.

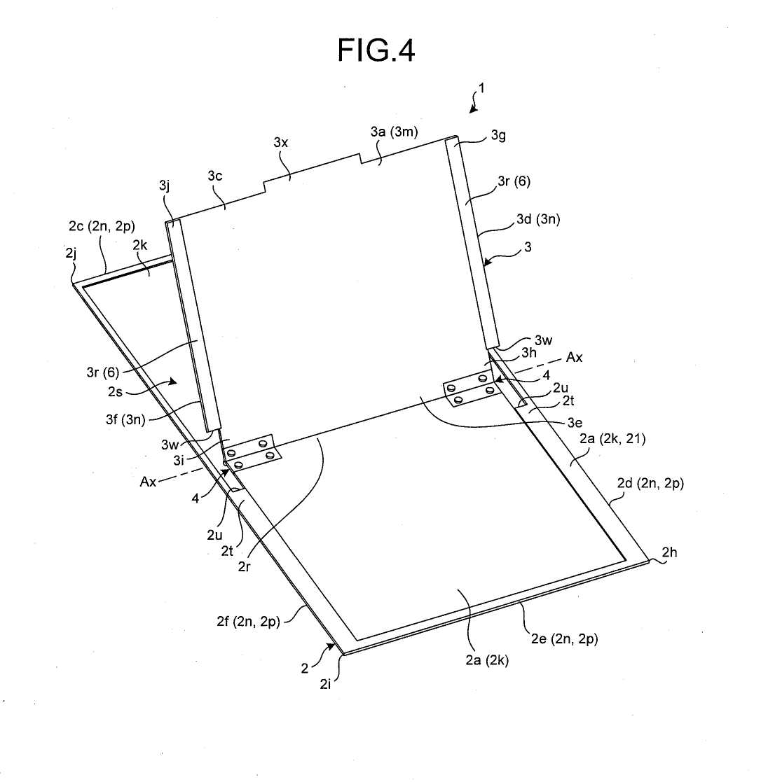

In the first embodiment, as an example, the second support 3 comprises a wall 3m including a surface 3a and the surface 3b. The wall 3m has a rectangular shape (in the first embodiment, an oblong shape, as an example). The second support 3 has four ends 3c to 3f (sides, edges) and four corners 3g to 3j (pointed portions, curved portions, ends) in the plan view, as illustrated in FIGS. 3 and 4. The ends 3c and 3e are examples of long sides. The ends 3d and 3f are examples of short sides. A protrusion 3x protruding toward the tip of the end 3c is provided on the end 3c of the second support 3. Therefore, according to the first embodiment, as an example, an operator can rotate the second support 3 by holding the protrusion 3x. In the first configuration, the protrusion 3x is exposed from the end 5c of the display 5 which is on the far side from the hinges 4.

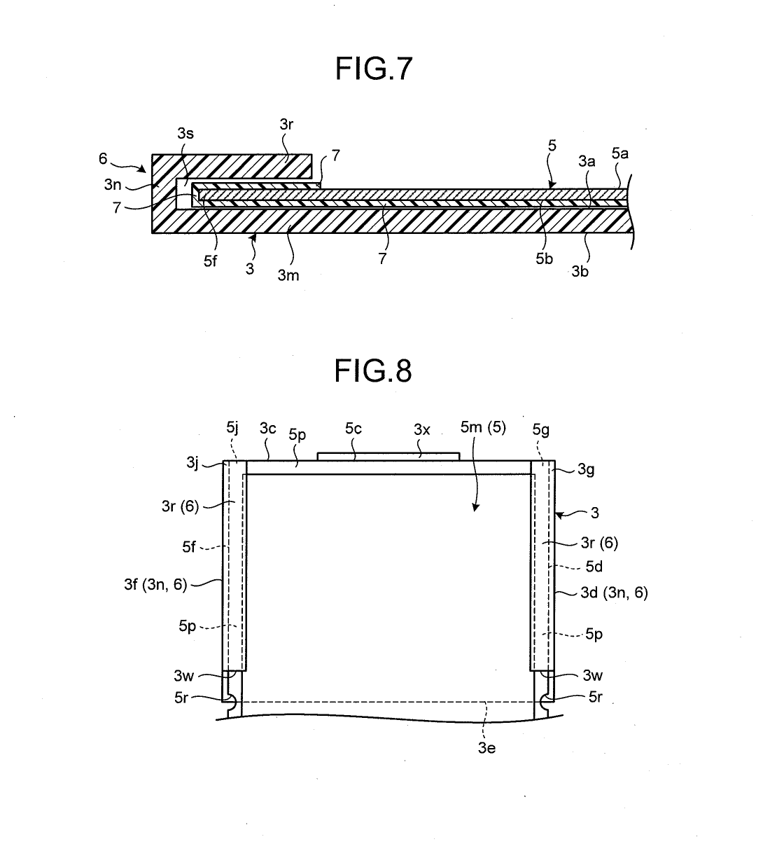

A wall 3n is provided on each of the ends 3d and 3f in a manner protruding from the surface 3a of the wall 3m, as illustrated in FIG. 7. Provided on the tip of each of the walls 3n is a flange-like wall 3r projecting in parallel with the wall 3m toward other end 3f, 3d. A space 3s is ensured between the wall 3m and the wall 3r. The ends 5d and 5f of the display 5 are housed in the respective spaces 3s. In other words, each of the ends 5d and 5f is surrounded by the walls 3m, 3n, and 3r.

In the first embodiment, as an example, the display 5 (a display unit, a display device, a component) is elastic, flexible, bendable, thin, and sheet-like (film-like). The display 5 is an LCD or an organic electroluminescent display (GELD), for example. The display 5 has a rectangular shape (in the first embodiment, an oblong shape, as an example), viewing in the thickness direction (plan view). The display 5 has a surface 5a (a front surface, a frontal surface, a top surface, a surface, a display surface, a display screen) from which images can be viewed, and a surface 5b (a rear surface, a back surface, a bottom surface, a behind surface; see FIGS. 7 and 12) located on the side opposite to the surface 5a. The display 5 also has four ends 5c to 5f (sides, edges) and four corners 5g to 5j (pointed portions, curved portions, ends) in the plan view. The ends 5c and 5e are examples of short sides. The ends 5d and 5f are examples of long sides.

In the first embodiment, as an example, the display 5 covers the surface 2a of the first support 2 and the surface 3a of the second support 3. In other words, the display 5 is laid over the surface 2a and the surface 3a. It can be also said that the surface 5b of the display 5 is covered by the first support 2 and the second support 3. The display 5 is supported by the first support 2 and the second support 3. An area 5n that is on one side of the display 5 in the longitudinal direction (in the first embodiment, a side near the end 5e, as an example) is supported by one side of the first support 2 in the longitudinal direction (in the first embodiment, a part nearer to the end 2e than the central part 2r, as an example). An area 5m on the other side of the display 5 in the longitudinal direction (in the first embodiment, the side near the end 5c, as an example) is supported by the second support 3. A band-like non-display area 5p is provided to the circumferential edge (ends 5c to 5f) of the display 5.

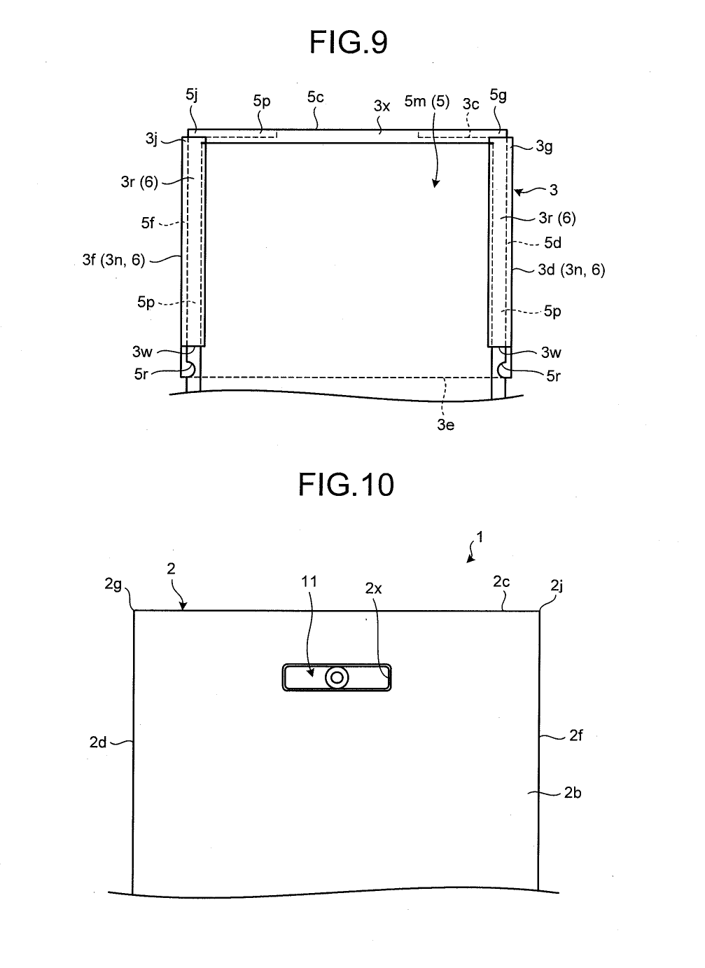

In the first embodiment, as an example, the area 5n including the end 5e of the display 5 is fixed to the first support 2, and the area 5m including the end 5c of the display 5 is supported by the first support 2 in a slidable (movable) manner. In the first embodiment, as an example, as illustrated in FIGS. 3 and 4, the first support 2 has fixed portions 2t (connected portions, supports, attached portions) to which the display 5 is fixed, and one end 2u of each of the fixed portions 2t near the hinge 4 is spaced from the corresponding hinge 4. One end 3w of the wall 3r of the second support 3 near the hinge 4 is also spaced from the hinge 4. The distance between the end 2u and the hinge 4 is almost equal to the distance between the end 3w and the hinge 4. With such a structure, in a configuration in which the first support 2 and the second support 3 are folded at the hinges 4 (in the second configuration), the display 5 is bent at a central part 5k (the central part in the longitudinal direction, a part located on top of the hinges 4, a bent part) located between the end 5c and the end 5e. Because the display 5 is elastic, the display 5 is bent between the end 2u and the end 3w, while ensuring a space between the display 5 and the hinges 4, as illustrated in FIGS. 2 and 13. By contrast, as the second support 3 is inclined and brought closer to the area near the end 2c of the first support 2, and becomes flat and continuous with the area near the end 2e of the first support 2 (in the first configuration), the display 5 is carried near the hinges 4, as illustrated in FIG. 12. In other words, in the first embodiment, through the deformation of the display 5 at a position near the hinges 4, the area 5m of the display 5 near the end 5c is carried nearer to the tip of the second support 3 in the second configuration illustrated in FIG. 9, compared with the first configuration illustrated in FIG. 8. In other words, as the first support 2 and the second support 3 are folded, the area 5m of the display 5 slides (moves) on the second support 3. Therefore, the walls 3m, 3n, and 3r are an example of third supports 6 respectively supporting the ends 5d and 5f of the area 5m of the display 5 in a slidable (movable) manner. Provided at the center of each of the ends 5d and 5f of the display 5 in the longitudinal direction (the position corresponding to the hinge 4, the position almost coming on top of the hinge 4) are cutouts 5r that face each other. Because higher stress is applied to the parts each having the cutout 5r when the display 5 is bent, the display 5 is bent more easily at where the cutout 5r are provided. Therefore, in the first embodiment, as an example, because the cutouts 5r are provided, a position at which or a form in which the display 5 is bent can be defined more easily, for example.

In the first embodiment, a friction reducer 7 is provided between the display 5 and the second support 3 so that the display 5 slides more smoothly on the second support 3 as the first support 2 and the second support 3 are folded. The friction reducer 7 is positioned between the display 5 and the walls 3m, 3n, and 3r, as illustrated in FIG. 7, as an example. The friction reducer 7 is provided on the surface 5b, the ends 5c, 5d, and 5f of the display 5, and on the circumferential edge of the surface 5a of the display 5 (only in the part corresponding to the ends 5c, 5d, and 5f). The friction reducer 7 may be made of a synthetic resin material that is relatively slippery, e.g., polytetrafluoroethylene. The friction reducer 7 may be provided by applying a layer on the display 5, or causing the friction reducer 7 to adhere to the display 5. By setting specifications such as the thickness or the hardness of the friction reducer 7 appropriately, the friction reducer 7 may also be used as a member for reinforcing the display 5.

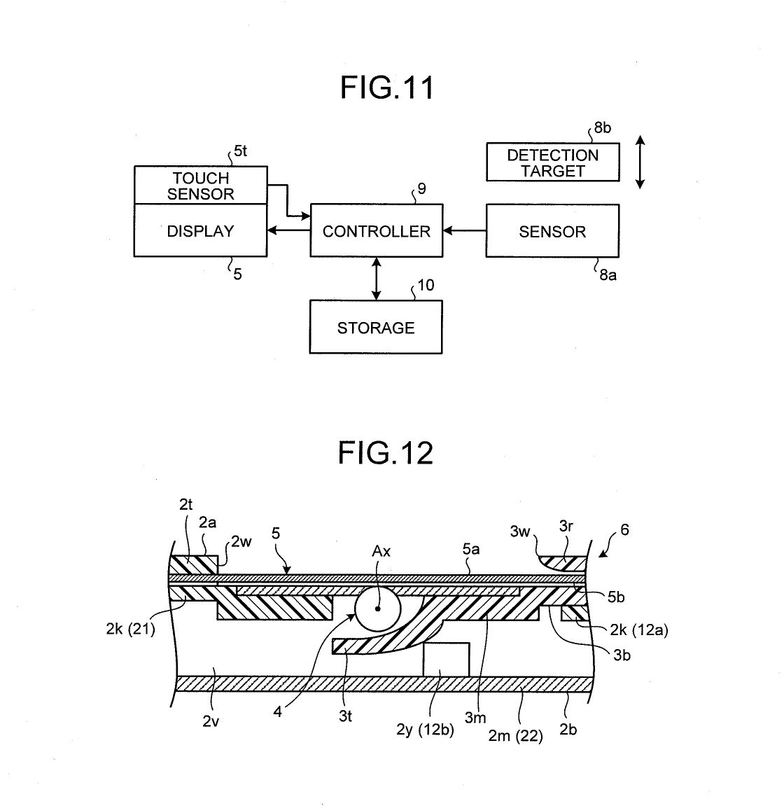

In the first embodiment, as an example, a touch sensor 5t (see FIG. 11) is provided to the display 5. The touch sensor 5t is colorless and transparent, and may be positioned in a layer comprising the display 5 or a layer covering the surface 5a of the display 5.

In the first embodiment, as an example, as illustrated in FIGS. 5 and 6, a sensor 8a enabled to detect that the first support 2 and the second support 3 are brought closer to each other or separated from each other is provided on at least one of the first support 2 and the second support 3. In the first embodiment, as an example, the sensor 8a (e.g., a Hall effect sensor) is provided to the first support 2, and a detection target 8b (object to be detected, part to be detected, detected object, such as a magnet) is provided on the second support 3 at a position facing the sensor 8a. In such a configuration, an output from the sensor 8a changes when the detection target 8b moves away from the sensor 8a by a given distance and when the detection target 8b and the sensor 8a move closer to each other. Therefore, a controller 9 can detect how far the first support 2 and the second support 3 are folded, and that the display 5 is bent, based on the detection result of the sensor 8a. In other words, the sensor 8a is an example of a sensor that can detect that the display 5 is bent.

In the first embodiment, as an example, as illustrated in FIG. 11, the electronic device 1 comprises the controller 9, the display 5 (display unit), the touch sensor 5t, the sensor 8a, and a storage 10 (e.g., a RAM, a ROM, or an SSD). The controller 9 can read a computer program installed in the storage 10 (for example, a non-volatile storage such as a ROM or an SSD), and perform various computations (processes) following the computer program thus read, for example. The controller 9 can also determine (judge) if the first support 2 and the second support 3 are folded (in the second configuration), in other words, if the display 5 is bent, using a detection result (detection signal) from the sensor 8a. When the first support 2 and the second support 3 are folded, in other words, when the display 5 is bent, the controller 9 can display an image for entering characters (e.g., an image not illustrated such as a keyboard or a frame for entering characters) in the area 5n of the display 5 located near the end 5e. The controller 9 can also acquire an input signal corresponding to such an image, based on a detection result from the touch sensor 5t.

While the first support 2 and the second support 3 are folded, in other words, while the display 5 is bent, the controller 9 does not execute any computations based on a detection signal from a part of the touch sensor 5t corresponding to an area 5s including the bent central part 5k of the display 5 (the area at a position corresponding to the hinges 4, the area coming on top of the hinges 4, the area adjacent to the hinges 4, a band-like area, as an example; see FIG. 2). In other words, the controller 9 disables (disregards) any input from the part of the touch sensor 5t corresponding to the area 5s. Therefore, the first embodiment can suppress, as an example, computations (processes) executed by the controller 9 based on a detection result of the touch sensor 5t (erroneous detection) caused by a bend in the display 5, instead of an input operation made on the touch sensor 5t by an operator.

In the first embodiment, as an example, as illustrated in FIGS. 5 and 6, a camera module 11 is provided to the second support 3. The first support 2 has an opening 2x (for example, a through-hole or a cutout) corresponding to the camera module 11. In the first embodiment, as an example, the opening 2x is provided as a through-hole penetrating through the first support 2 in the thickness direction. The camera module 11 is inserted in the opening 2x in the first configuration, as illustrated in FIGS. 5 and 10, and can capture an image of an area on the side opposite to the display 5 with respect to the first support 2 (in FIG. 5, the area below the first support 2). In the second configuration, the camera module 11 can capture an image of an area located on the side opposite to the display 5 with respect to the second support 3 (in FIG. 6, the area located on the right side of the second support 3).

In the first embodiment, as an example, as illustrated in FIG. 12, the electronic device 1 is provided with a first rotation suppressor 12a. The first rotation suppressor 12a comprises the wall 2k (a protrusion, a rib, a projection, a stepped portion, a support) abutting against the wall 3m of the second support 3, as an example. When the second support 3 is rotated, the second support 3 abuts against the first rotation suppressor 12a, so that rotation of second support 3 is suppressed any further in the clockwise direction in FIG. 12 from the position (angle) illustrated in FIG. 12. In other words, the first rotation suppressor 12a suppresses rotation of the first support 2 and the second support 3 in a direction causing the area 5s (the central part 5k) of the display 5 to protrude upwardly (toward the front side, frontal surface) on the surface 5a (display surface).

In the first embodiment, as an example, as illustrated in FIG. 13, the electronic device 1 is also provided with a second rotation suppressor 12b. The second rotation suppressor 12b is a protrusion 2y (a wall, a rib, a projection, a stepped portion, a support) that is provided on the wall 2m of the first support 2, as an example, in a manner protruding toward the wall 2k within the space 2v, and abuts against an arm 3t provided to the wall 3m of the second support 3. When the second support 3 is rotated, the second support 3 abuts against the second rotation suppressor 12b, and in this manner, rotation of the second support 3 is suppressed any further in the counterclockwise direction in FIG. 13 from the position (angle) illustrated in FIG. 13. In other words, the second rotation suppressor 12b suppresses rotation of the first support 2 and the second support 3 from the position (angle, setting) illustrated in FIG. 13, where the area 5s of the display 5 protrudes toward a space below the surface 5a (toward the behind side, rear side), any further in a direction in which one end of the surface 5a (the side of the end 5e, the left side in FIG. 13) and the other end (the side of the end 5c, the upper side in FIG. 13) face each other. In other words, bending of the display 5 by a larger degree is suppressed.

As explained above, in the first embodiment, as an example, the electronic device 1 may be positioned in the first configuration in which the first support 2 and the second support 3 become adjacent to each other and the display 5 becomes approximately flat, and the second configuration in which the first support 2 and the second support 3 are separated from each other and the display 5 is bent between one end (the side of the end 5e) and the other end (the side of the end 5c) of the display 5. Therefore, according to the first embodiment, as an example, in the electronic device 1 capable of changing its form into a tablet form and a clam-shell form, because the support (housing) is not folded together (does not overlap each other) in a manner causing the end 5c and the end 5e of the display 5 to face each other, the thickness of the electronic device 1 can be reduced. Furthermore, because the flexible display 5 does not need to be bent by a large degree, the reliability of the display 5 can be improved more easily, and the display 5 and the electronic device 1 can be manufactured more inexpensively, for example. Furthermore, the second support 3 is more stably supported by the first support 2 in the first configuration. The electronic device 1 may comprise a snap-fit mechanism (not illustrated) for allowing the first support 2 and the second support 3 to be elastically attached or removed from each other in the first configuration.

In the first embodiment, as an example, the second support 3 comprises the third supports 6 respectively supporting the ends 5d and 5f of the display 5 located in a direction intersecting with a direction extending between the end 5c and the end 5e in a slidable manner. Therefore, the display 5 can be supported more stably, regardless of an angle at which the first support 2 and the second support 3 are folded.

In the first embodiment, as an example, each of the third supports 6 (ends 3w of the walls 3r near the hinges 4) is provided in a manner spaced from the corresponding one of the hinges 4. Therefore, according to the first embodiment, as an example, the display 5 is bent at a larger curvature radius. Therefore, as an example, the reliability of the display 5 is improved.

In the first embodiment, as an example, the friction reducer 7 for reducing the friction between the display 5 and the second support 3 is provided between the display 5 and the second support 3. Therefore, the first embodiment can readily suppress, as an example, engagement of the display 5 while being slid with the second support 3. Therefore, as an example, inconveniences caused by the display 5 being grabbed by the second support 3 when the display 5 is slid are experienced less.

In the first embodiment, as an example, the friction reducer 7 is provided on the surface 5b (rear surface) of the display 5. Therefore, according to the first embodiment, as an example, the friction reducer 7 can be provided more easily. Furthermore, as an example, the friction reducer 7 can reinforce the display 5. Furthermore, the friction reducer 7 provided on the circumferential edge of the surface 5a of the display 5 can be used as non-display area of the surface 5a of the display 5 (a display surface, a display screen).

Furthermore, in the first embodiment, as an example, the electronic device 1 comprises the sensor 8a capable of detecting that the display 5 is bent. Therefore, according to the first embodiment, as an example, a display on the display 5 can be changed depending on the detection result of the sensor 8a.

Furthermore, in the first embodiment, as an example, when the display 5 is detected to be bent, the controller 9 does not perform a process based on a detection result from the part if the touch sensor 5t corresponding to the area 5s including the bent central part 5k of the display 5. Therefore, the first embodiment can suppress, as an example, incorrect computations executed by the controller 9 based on an erroneous detection in the touch sensor 5t caused by the bending display 5.

Furthermore, in the first embodiment, as an example, the second support 3 is provided with the camera module 11, and the first support 2 is provided with the opening 2x that allows the camera module 11 to capture an image of an area located on the side opposite to the display 5 with respect to the first support 2 in the first configuration. Therefore, according to the first embodiment, as an example, the camera module 11 may be used in both of the first configuration and the second configuration.

Furthermore, in the first embodiment, as an example, the first support 2 (housing) is provided with the space 2v stretching across the end 2c and the end 2e. Therefore, according to the first embodiment, as an example, compared with a structure in which the housing and the housing are divided at the hinges 4, a larger space 2v can be ensured in the first support 2. Therefore, as an example, a larger battery can be housed in the space 2v.

Furthermore, in the first embodiment, as an example, the electronic device 1 comprises the first rotation suppressor 12a and the second rotation suppressor 12b. Therefore, according to the first embodiment, as an example, the electronic device 1 and the display 5 can be used at a flat, open posture (tablet form), a folded posture at which the first support 2 and the second support 3 are folded at a predetermined angle where these supports do not overlap each other (clam-shell form), and postures between these two. Therefore, as an example, because the first support 2 and the second support 3 are avoided from overlapping each other, the thickness of the electronic device 1 can be reduced, and the reliability of the display 5 can be improved.

First Modification

A second support 3A according to a first modification illustrated in FIG. 14 may be used instead of the second support 3 included in the electronic device 1 according to the first embodiment. In the first modification, as an example, the second support 3A is provided with openings 3u (through-holes or recesses each with a bottom, for example; in the first modification, through-holes, as an example) each having a polygonal shape (in the first modification, a hexagonal shape, as an example) viewing in the thickness direction (plan view). The opening 3u are arranged at the same orientation, and a frame 3v is positioned between a plurality of the openings 3u. According to the first modification, as an example, the second support 3A can be reduced in weight, and therefore, the electronic device 1 can be reduced in weight.

Second Modification

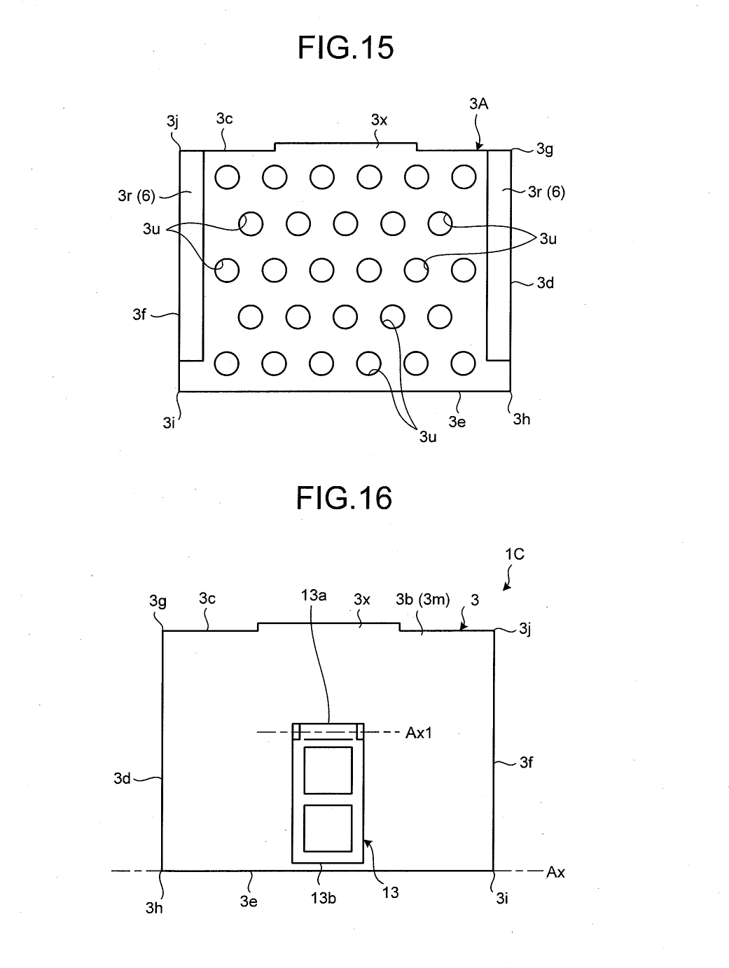

A second support 3B according to a second modification illustrated in FIG. 15 may be used instead of the second support 3 included in the electronic device 1 according to the first embodiment. In the second modification, as an example, the second support 3B is provided with circular openings 3u (through-holes or recesses each with a bottom, for example; in the first modification, through-holes, as an example) viewing in the thickness direction (plan view). According to the second modification as well, as an example, the second support 3B can be reduced in weight, and therefore, the electronic device 1 can be reduced in weight.

Third Modification

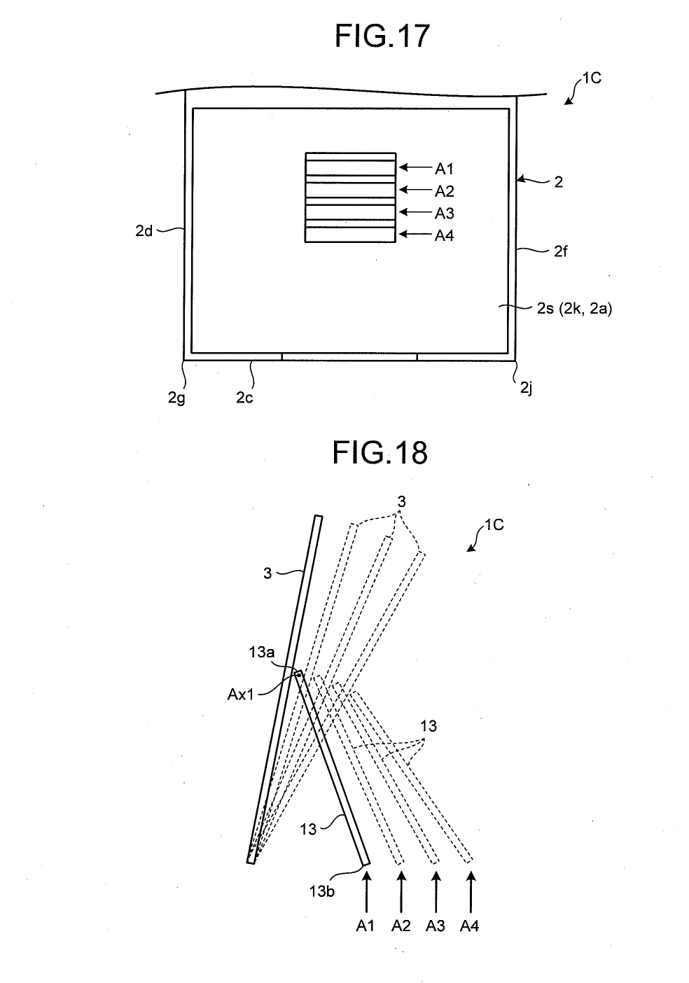

An electronic device 1C according to a third modification illustrated in FIGS. 16 to 18 comprises a fourth support 13 that supports the second support 3 against the first support 2. In the third modification, as an example, the fourth support 13 is provided on the surface 3b of the second support 3, and rotatably supported by the second support 3. In the first configuration, the fourth support 13 can be folded and housed in a manner following the surface 3b of the second support 3. A rotational axis Ax1 of the fourth support 13 is in parallel with the rotational axis Ax of the hinges 4. The fourth support 13 has a shape of a plate or a frame. An end 13a (an upper end, one end) of the fourth support 13 is rotatably connected to the second support 3. An end 13b (a lower end, the other end) of the fourth support 13 located on the side opposite to the end 13a is supported by the first support 2. The first support 2 is provided with a variable support 14 (support) that supports the end 13b at different supporting positions A1 to A4. The distance from the hinge 4 to each of the supporting positions A1 to A4 is different. The variable support 14 may be provided as stepped portions or recesses on the wall 2k of the first support 2. Therefore, according to the third modification, the second support 3 can be supported by the fourth support 13 against the first support 2 more firmly. Furthermore, according to the third modification, the angle of the second support 3 can be set variably, by changing the supporting positions A1 to A4 of the fourth support 13, as illustrated in FIG. 18.

Furthermore, structures, shapes, and the like according to each of the embodiment and the modifications may be partly changed in implementations. Furthermore, specifications such as structures and shapes (e.g., structures, types, directions, shapes, sizes, lengths, widths, thicknesses, heights, numbers, arrangements, positions, and materials) may be changed as appropriate. Furthermore, in the embodiment and the modifications, the display may be fixed to the second support, and may be slidably (movably) supported by the first support. Furthermore, the position where the first support and the second support are folded (position where the first support and the second support are connected), the number of bent, and the direction of the bent may also be changed as appropriate. For example, the electronic device may be configured to be folded (enabled to be folded) in a short-side direction at a bending position along the longitudinal direction (bending line, border line). Furthermore, the embodiment and the modifications may be implemented as an electronic device in which a separate display (component; e.g., a relatively hard display panel having an inflexible glass panel) is supported by each of a first housing (a first support) and a second housing (a second support), with which the first rotation suppressor and the second rotation suppressor are provided. Such an electronic device can also achieve the same advantageous effects that are based on the similar structures.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a flexible display comprising a front surface configured to display an image to be viewed and a rear surface located on a side opposite to the front surface;
a first support configured to support one end of the display, and to be positioned on the rear surface of the display across the one end and the other end of the display when the display is approximately flat;
a second support configured to support the other end of the display, and to be positioned between the display and the first support; and
a hinge configured to rotatably connect the first support and the second support, wherein
the electronic device is configured to be used in a first configuration in which the first support and the second support come near each other and the display becomes approximately flat, and a second configuration in which the first support and the second support are separated from each other and the display is bent at a position between the one end and the other end.

2. The electronic device of claim 1, wherein at least one of the first support and the second support comprises a third support configured to slidably support an end of the display along a direction intersecting with a direction extending between the one end and the other end.

3. The electronic device of claim 2, wherein the third support is configured to be spaced apart from the hinge.

4. The electronic device of claim 1, further comprising a friction reducer between the display and the second support configured to reduce a friction between the display and the second support.

5. The electronic device of claim 4, wherein the friction reducer is on the rear surface.

6. The electronic device of claim 1, further comprising a sensor configured to detect when the display is bent.

7. The electronic device of claim 6, further comprising:
a touch sensor configured to detect an input operation on the front surface; and
a controller configured to perform a process corresponding to a detection result from the touch sensor, wherein
the controller is configured not to perform the process corresponding to the detection result from an area of the touch sensor including a bent portion of the display when the display is detected to be bent.

8. The electronic device of claim 1, wherein
the second support comprises a camera, and
the first support comprises an opening configured to allow the camera to capture an image of an area on a side opposite to the display with respect to the first support in the first configuration.

9. The electronic device of claim 1, wherein inside of the first support comprises a space stretching across the one end and the other end.

10. The electronic device of claim 1, further comprising a fourth support configured to support the second support against the first support.

11. An electronic device comprising:
a flexible display comprising a display surface;
a first support configured to be positioned on a rear side of the display surface on one end of the display surface;
a second support configured to be positioned on the rear side of the display surface on the other end of the display surface;
a hinge configured to rotatably connect the first support and the second support;
a first rotation suppressor configured to be fixed to one of the first support and the second support to suppress rotation of the other one of the first support and the second support in a direction causing a central part of the display between the one end and the other end of the display surface to protrude toward front of the display surface; and
a second rotation suppressor configured to be fixed to the one of the first support and the second support and to support the other one of the first support and the second support to suppress rotation of the first support and the second support, in a direction causing the one end and the other end of the display surface of the display to face each other, from a predetermined angle at which the first support and the second support are bent in a manner such that the central part of the display protrudes toward rear of the display surface.

12. An electronic device comprising:
a first support configured to support a component comprising a display surface;
a second support configured to support the component;
a hinge configured to rotatably connect the first support and the second support;
a first rotation suppressor configured to be fixed to one of the first support and the second support and to support the other one of the first support and the second support to suppress bending of the one and the other one in a manner protruding toward front of the display surfaces of the first support and the second support at the hinge; and
a second rotation suppressor configured to be fixed to the one of the first support and the second support and to support the other one of the first support and the second support to suppress rotation of the one and the other, in a direction causing the display surface of the one and the display surface of the other to move closer to each other, from a predetermined angle at which the first support and the second support are bent.

13. The electronic device of claim 12, wherein the first rotation suppressor is configured to entirely cover a side opposite to the display surface of the other.
